(19) United States
(12) Patent Application Publication
(10) Pub. No.: US 2010/0054891 A1
(43) Pub. Date: Mar. 4, 2010

(54) FASTENING APPARATUS AND SYSTEM FOR DETECTING AXIAL FORCE THEREOF

(75) Inventors: Eiji Nishida, Yokohama (JP); Fumiyoshi Hashimoto, Yokohama (JP)

Correspondence Address: RABIN & Berdo, PC, 1101 14TH STREET, NW, SUITE 500, WASHINGTON, DC, 20005, US

(73) Assignee: ASAHI ELECTRIC WORKS, LTD., Kanagawa-ken (JP)

(21) Appl. No.: 12/490,995

(22) Filed: Jun. 24, 2009

(30) Foreign Application Priority Data
Aug. 27, 2008 (JP) 2008-218312

(51) Int. Cl. F16B 31/02

(52) U.S. Cl. 411/9; 73/761

(57) ABSTRACT

A detecting system of a fastening apparatus that detects an axial force of the fastening apparatus including a bolt or a nut. The detecting system includes an axial force detector including a strain gauge and an IC tag, the strain gauge being provided at a predetermined location to detect an axial force value of the fastening apparatus, and the IC tag being connected to the strain gauge and wirelessly transmitting the detected axial force value and unique identification information. Power is supplied to the axial force detector. A reader reads data transmitted from the axial force detector.

### BACKGROUND OF THE INVENTION

1. Field of the Invention

The present invention relates to a fastening apparatus for fastening a member using a fastener such as a bolt or a nut, and to a detecting system of the fastening apparatus for detecting and managing an axial force during fastening.

2. Description of the Related Art

Many fastening means are intended to keep a constant axial force in order to enhance reliability of a fastening section where a fastener such as a bolt or a nut is fastened.

For example, such fastening means include: 1) fastening using a torque wrench; 2) incorporating a breakaway mechanism; and 3) adopting an SP locknut (constant axial force locking nut).

However, these fastening means have various disadvantages.

In fastening using a torque wrench, even when a bolt or a nut is fastened to the same torque set by the torque wrench, each obtained axial force varies because the bolt or the nut is affected by a difference in friction coefficient from its fastener counterpart.

On the other hand, a fastening apparatus having a breakaway mechanism and an “SP locknut” which is a constant axial force locking nut are intended to obtain constant torque without using a torque wrench, but have a critical disadvantage in that the axial force varies due to friction between fasteners as mentioned above.

Moreover, in the case of a breakaway-type fastening apparatus, for construction management it is necessary to check again, through the use of a torque wrench, whether or not fastening is performed to specified torque. However, such check or inspection is not easy when a fastening section is situated at a transmission and distribution line tower, an electric wire, and the like.

As to a fastener having a breakaway mechanism, there is a possibility of a trouble in which a hexagonal portion after a breakaway portion breaks away is directly fastened. This causes fastening to be performed to torque that is totally different from specified torque, and results in poor construction.

In the case of the SP locknut, it cannot be known from an outer appearance whether or not fastening is completed, which makes it impossible to conduct management and inspection after construction.

As described above, though the conventional fastening means are acceptable in that a probability of a mistake can be reduced to improve fastening, it is impossible to ascertain whether or not fastening is proper unless inspection is conducted after fastening.

Besides, even when proper fastening is performed, the axial force is indirectly managed by fastening torque, so that the obtained axial force inevitably has relatively wide variations for the above-mentioned reason.

For example, the following patent documents were filed by the applicant of this application in connection with the technical field of the present invention.

[Patent Document 1] Japanese Patent Application Laid-Open No. 2006-144838

[Patent Document 2] Japanese Patent Application Laid-Open No. 2001-173626

[Patent Document 3] Japanese Patent Publication No. 6-72606

### SUMMARY OF THE INVENTION

As described above, the conventional techniques relating to fastening fail to significantly reduce troubles caused by looseness of a fastening section and the like. In addition, there is a design requirement of a higher safety margin than necessary, in order to prevent apparatus damage caused by fastening a bolt or the like too tightly. This leads to increases in apparatus weight and cost.

To solve the conventional problems described above, the present invention has objects such as: directly measuring and detecting an accurate axial force during construction; easily inspecting and managing an axial force of a fastening section at an arbitrary time by using a reader that has a function of transmitting to a personal computer and the like; and providing an axial force detection-type bolt and nut at relatively low prices.

(1) A fastening apparatus has means for detecting a fastening axial force value, and includes: an axial force detector including a strain gauge and an IC tag, the strain gauge being provided at a predetermined location to detect the axial force value, and the IC tag being connected to the strain gauge and wirelessly transmitting the axial force value detected by the strain gauge and unique identification information; and means for supplying power to the axial force detector.

(2) The fastening apparatus of (1) includes a bolt or a nut, and the strain gauge and the IC tag are positioned so as not to contact a fastening tool when the fastening apparatus is fastened using the fastening tool.

(3) A detecting system of a fastening apparatus has means for detecting an axial force of the fastening apparatus including a bolt or a nut, and includes: an axial force detector including a strain gauge and an IC tag, the strain gauge being provided at a predetermined location to detect an axial force value of the fastening apparatus, and the IC tag being connected to the strain gauge and wirelessly transmitting the detected axial force value and unique identification information; means for supplying power to the axial force detector; and a reader for reading data transmitted from the axial force detector.

Many troubles of fastening apparatuses are considered to be caused by an improper axial force during fastening. In view of this, according to the present invention, the axial force can be directly measured and detected during construction, so that troubles such as looseness can be prevented from occurring by verifying that the axial force is a desired axial force.

In the present invention, when using a reader that has a function of transmitting to a personal computer and the like, the axial force of the fastening section can be easily inspected at an arbitrary time just by bringing the reader close to the fastening section.

Moreover, the axial force of the fastening section can be constantly monitored by placing the reader close to the fastening section.

Furthermore, by applying the system or method according to the present invention, it is possible to monitor accidents such as an unexpected force (significant axial force change) acting upon the fastening section. For instance, adopting this technique in important security units such as nuclear equipment, automobile, aircraft, and railroad contributes to prevention of accidents and determination of causes of accidents.

In addition, in the case where a bolt to which the technique of the present invention is applied is used to fix a rail to a railroad tie, the looseness of the bolt can be inspected at high speed on a regular basis by installing an appropriate reader in a high-speed test vehicle, which contributes to labor savings and safety improvements.

### BRIEF DESCRIPTION OF THE DRAWINGS

FIG. 1 is a block diagram showing an example of a detecting system of a fastening apparatus according to the present invention.

FIG. 2 is a diagram showing an example of a circuit structure of a strain gauge used in the present invention.

FIG. 3 is an external perspective view showing an example of providing a strain gauge and an IC tag on a bolt and a nut of the fastening apparatus according to the present invention.

### DESCRIPTION OF THE PREFERRED EMBODIMENTS

The following provides a detailed description of an embodiment of a fastening apparatus and a system for detecting an axial force thereof according to the present invention, with reference to attached drawings.

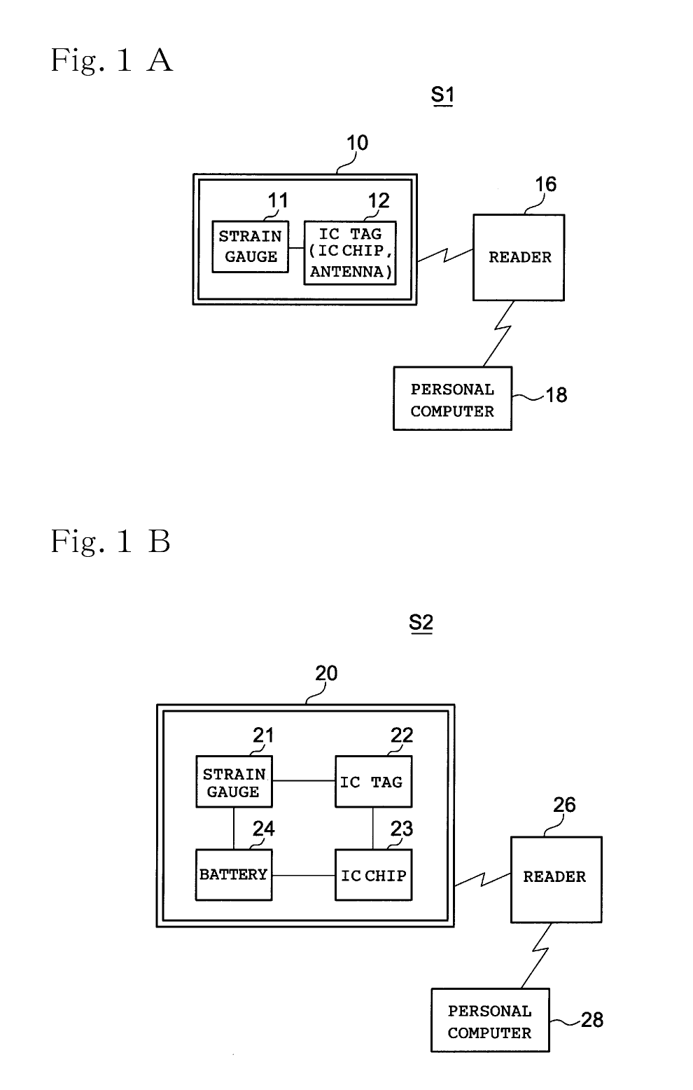

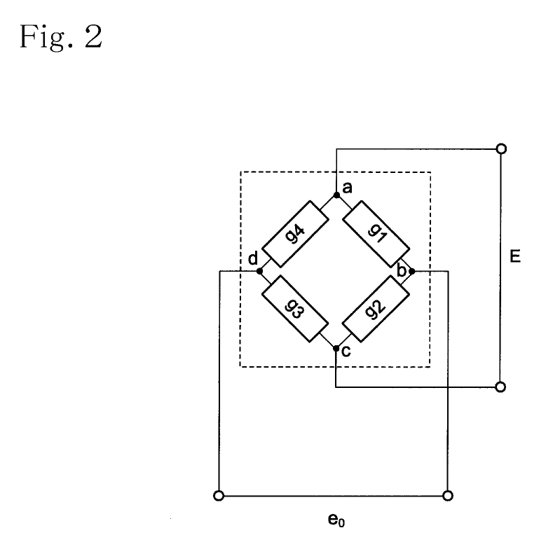

FIG. 1 is a block diagram of an axial force detecting system (S1, S2) of a fastening apparatus.

The axial force detecting system S1 shown in FIG. 1A has means for detecting a fastening axial force of a fastening apparatus including a bolt or a nut, and is composed of a structure in which “an axial force detector 10—a reader 16—a personal computer 18” are connected together. “The axial force detector 10—the reader 16” are connected wirelessly, and “the reader 16—the personal computer 18” are connected wirelessly or wiredly.

The axial force detector 10 includes a strain gauge 11 that is attached at a predetermined location to detect an axial force value of the fastening apparatus, and an IC tag 12 that is connected to the strain gauge 11 and wirelessly transmits the detected axial force value.

The IC tag 12 is a commonly used IC tag that includes an IC chip (microchip) and an antenna and has unique identification information. The microchip of the IC tag is provided with any function necessary for strain detection by the strain gauge, and as power supply an induced current generated by an electric wave from the reader 16 to the antenna included in the IC tag 12 is used.

The axial force detector 10 formed by integrating the IC tag 12 and the strain gauge 11 in this way is made as compact as possible so as to be incorporated in a commercial bolt or nut. The axial force detector 10 is then attached to an axial force measurement portion of a fastener such as a bolt or a nut. At this time, the axial force detector 10 is attached at such a position that does not interfere with a fastening tool when tightening the fastener using the fastening tool. This axial force detector 10 including the IC tag 12 and the strain gauge 11 has a size small enough to be incorporated in a commercial bolt or nut.

In the axial force detecting system S1 shown in FIG. 1A, the axial force detector 10 detects a strain change corresponding to an axial force change of the bolt or nut by the strain gauge 11 and then transmits the detected strain change to the reader 16, using a current generated in the antenna upon receiving an electric wave from the wirelessly-connected reader 16 as a driving source.

Moreover, the personal computer 18 is installed around the reader 16 so that the detection result can be transmitted wirelessly or wiredly.

The IC tag 12 in the axial force detector 10 can not only transmit the axial force value of the fastening apparatus detected by the strain gauge, but also simultaneously transmit unique identification information relating to the fastening section (measurement portion).

The IC tag 12 employed in the present invention is a contactless IC tag called “RFID” that carries an antenna and an IC chip having a memory function, and is capable of receiving and communicating an electric wave of a predetermined frequency by forming a resonant circuit from a capacitor and a coil pattern on a substrate of a plastic or the like. Frequency bands typically used are: below 125 kHz; 13.56 MHz; 2.45 GHz (microwave); and UHF. A communication distance in the case of microwave was considered to be several meters, but structures that achieve longer communication distances have been developed in recent years.

The IC tag tends to be affected by electrical noise, moisture, metal, and so on depending on its frequency band. Therefore, an IC tag of an appropriate frequency band needs to be selected in accordance with a material, an installation environment, and the like of the fastener whose axial force is to be measured. In particular, since the fastener is often made of metal such as iron, aluminum, or copper, the selection of the appropriate IC tag is essential.

FIG. 2 shows a specific example of a circuit diagram of the strain gauge 11 used for axial force detection in the axial force detecting system of the present invention. This strain gauge 11 is composed of a Wheatstone bridge circuit which includes four strain gauges g1 to g4. In strain measurement, a 4-gauge bridge circuit is formed in such a manner that resistances of these four strain gauges alternately enter in pairs, as a result of which a strain output is produced. When a bridge voltage is applied to E, a strain voltage corresponding to a physical quantity of a detection target is obtained.

The axial force detecting system S2 shown in FIG. 1B is similar to the axial force detecting system S1, in that the axial force detecting system S2 has means for detecting a fastening axial force of a fastening apparatus including a fastener such as a bolt or a nut and is composed of a structure in which “an axial force detector 20—a reader 26—a personal computer 28” are connected together. However, the axial force detecting system S2 is different from the axial force detecting system S1, in that the axial force detector 20 shown in FIG. 1B includes a battery 24 which serves as a driving source for strain measurement and reception/transmission and another IC chip 23 (microchip) is provided with any function necessary for measurement by a strain gauge.

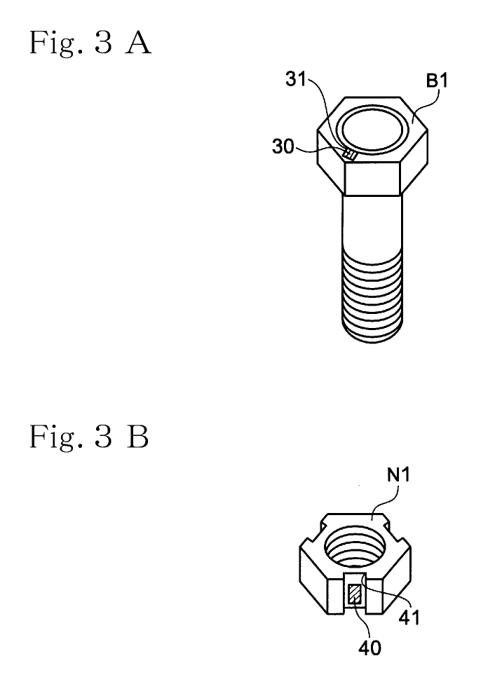

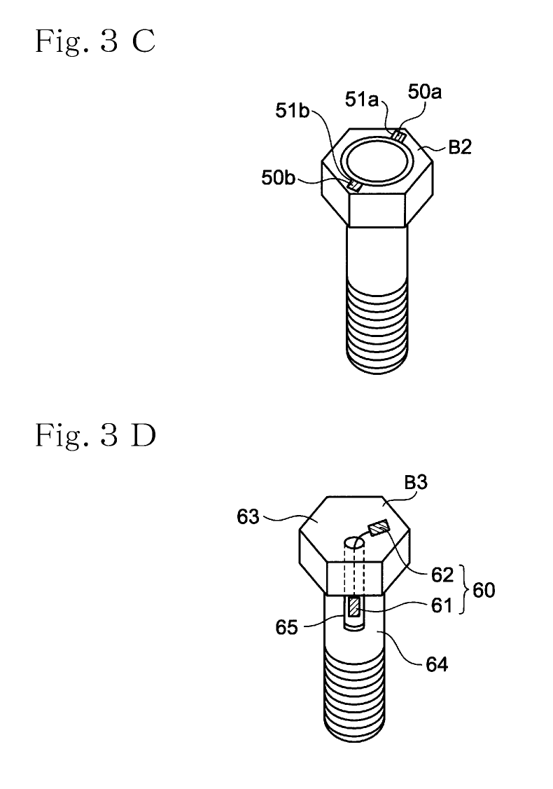

FIG. 3 is an external perspective view showing a situation where an axial force detector is provided on a fastener such as a bolt or a nut.

FIG. 3A shows a situation where an axial force detector 30 including a strain gauge and an IC tag is provided on a hexagonal surface of a hexagonal head of a bolt B1 for fastening. Here, the axial force detector 30 is disposed in a groove 31 which is formed on the surface of the hexagonal head. Thus, the axial force detector 30 shown in FIG. 3A is attached at such a position that does not contact a fastening tool during construction, i.e., a position that does not interfere with construction.

In the type such as FIG. 3A where the strain gauge is provided on the hexagonal head of the bolt B1, instead of detecting an axial force of a body of the bolt, a tensile stress caused by the axial force is converted to a bending stress at the head of the bolt and the bending stress is detected by the integrated axial force detector 30. This allows for applications to bolts with relatively low accuracy and at low cost.

Next, FIG. 3B shows a situation where an axial force detector 40 including a strain gauge and an IC tag is provided on a hexagonal cross-section nut N1 for fastening. Since upper and lower hexagonal surfaces of the nut N1 contact other members and also side surfaces of the nut N1 contact a fastening tool, the axial force detector 40 is disposed in a groove 41 formed by depressing a side surface.

Next, FIG. 3C shows a situation where two axial force detectors (50a, 50b) each including a strain gauge and an IC tag are provided in grooves (51a, 51b) on a hexagonal surface of a hexagonal head of a bolt B2 for fastening which is similar to the one shown in FIG. 3A, symmetrically about a center of the hexagonal surface. The two axial force detectors (50a, 50b) are positioned so as not to contact a fastening tool during construction and not to interfere with construction.

In the case where relatively low accuracy and low cost are required as in FIG. 3A, it is preferable that, instead of detecting the axial force of the body of the bolt, the groove is formed in the head, and the tensile stress caused by the axial force is converted to the bending stress and the bending stress is detected by the integrated axial force detector. In this case, since it is difficult to respond to an unbalanced load when the axial force detector is provided in one place (FIG. 3A), the axial force detector may be provided in two places (FIG. 3C) or in three places depending on cost and detection accuracy requirements. When the axial force detector is provided in a plurality of places, detection values received by a personal computer or the like are averaged and put to use.

FIG. 3D shows another situation where an axial force detector 60 is provided on a bolt B3 for fastening which has a hexagonal head similar to the one shown in FIG. 3A. In FIG. 3D, a strain gauge 61 and an IC tag 62 are not included together in the axial force detector 60, but disposed at separate positions though they are connected to each other.

In detail, a through groove 65 that penetrates from a hexagonal surface of a hexagonal head 63 through to a side surface of a shaft 64 is formed in the bolt B3. The strain gauge 61 is disposed in the through groove 65 on the side surface of the body (shaft) 64 while the IC tag 62 is disposed on the hexagonal surface of the hexagonal head 63, and the strain gauge 61 and the IC tag 62 are connected to each other by a lead wire.

Here, because the strain gauge 61 is positioned at the side surface of the body 64, an axial force acting upon the body 64 of the bolt B3 can be measured accurately.

The technique of the present invention enables accuracy and cost to be freely applied according to a purpose and a required level. For example, when relatively high cost is permitted as in the case of an important security unit such as nuclear equipment, the axial force detector may be housed in the groove formed on the surface of the body of the bolt so as not to interfere with a bolt operation and also not to damage the axial force detector, as shown in FIG. 3D.

In FIG. 3D, the strain gauge 61 is located at the body 64 of the bolt so that the axial force can be directly detected with high accuracy, and the IC tag 62 is located at the head of the bolt to allow an electric wave to be transmitted/received. The strain gauge 61 and the IC tag 62 are connected to each other by a lead wire, and attached to the bolt by a high weatherproof adhesive.

The type of separating the strain gauge and the IC tag and electrically connecting them by a lead wire as shown in FIG. 3D requires higher cost than the one shown in FIG. 3A. Accordingly, these different types may be selectively used for different applications of axial force detection and the like.

When the technique of the fastening apparatus and the system for detecting an axial force thereof according to the present invention is applied to a fastener such as a bolt or a nut, an axial force can be contactlessly measured on the spot immediately after construction.

Transmitting a result of the measurement to a personal computer or the like of an administrator via a reader or the like enables the administrator to instantly determine whether or not the axial force is proper. When the axial force is not proper, the administrator instructs an operator to make a correction. Thus, the desired axial force can be obtained reliably.

Moreover, individual identification information of the fastening apparatus can be recorded in the personal computer or the like together with the measured axial force, thereby providing management data for subsequent inspection.

An axial force detector is formed by integrating a strain gauge and an IC tag. A microchip of the IC tag may be provided with a function for enabling axial force measurement by the strain gauge, and as power supply an induced current generated by an electric wave from a reader to an antenna included in the IC tag may be used. Alternatively, as in the system shown in FIG. 1B, another IC tag (microchip) may be provided with the function necessary for the measurement by the strain gauge, and a battery as a power source may be integrally included.

Such an axial force detector that integrates the strain gauge and the IC tag can be easily manufactured compactly so as to be incorporated in a commercial bolt or nut. As an alternative, the strain gauge and the IC tag may be separated and electrically connected by a lead wire depending on the application.

What is claimed is:

1. A fastening apparatus having means for detecting a fastening axial force value, the fastening apparatus comprising:
an axial force detector including a strain gauge and an IC tag, the strain gauge being provided at a predetermined location to detect the axial force value, and the IC tag being connected to the strain gauge and wirelessly transmitting the axial force value detected by the strain gauge and unique identification information; and
means for supplying power to the axial force detector.

2. The fastening apparatus as claimed in claim 1, wherein the fastening apparatus includes a bolt or a nut, and
wherein the strain gauge and the IC tag are positioned so as not to contact a fastening tool when the fastening apparatus is fastened using the fastening tool.

3. An axial force detecting system of a fastening apparatus, the axial force detecting system having means for detecting an axial force of the fastening apparatus that includes a bolt or a nut, the axial force detecting system comprising:
an axial force detector including a strain gauge and an IC tag, the strain gauge being provided at a predetermined location to detect an axial force value of the fastening apparatus, and the IC tag being connected to the strain gauge and wirelessly transmitting the detected axial force value and unique identification information;
means for supplying power to the axial force detector; and
a reader for reading data transmitted from the axial force detector.
